(19) United States
(12) Patent Application Publication
(10) Pub. No.: US 2004/0129322 A1
(43) Pub. Date: Jul. 8, 2004

(54) Pressure control valve for controlling two pressure load paths

(75) Inventor: Jianping Chen, Gurnee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: HydraForce, Inc., Lincolnshire, IL

(21) Appl. No.: 10/714,059

(22) Filed: Nov. 14, 2003

Related U.S. Application Data
(60) Provisional application No. 60/426,932, filed on Nov. 15, 2002.

(51) Int. Cl. F15B 13/044

(52) U.S. Cl. 137/625.65

(57) ABSTRACT

A dual proportional pressure control valve can include a cage, a spool, and an electromagnetic proportional actuator having a pair of coils. The control valve can deliver a stable secondary pressure to one of two different load ports from a primary pressure source. Which load port receives the secondary pressure can be dependent upon which coil of the activator is energized. Since the spool is driven directly by the electromagnet to control its sliding position, its secondary pressure can correspond to the strength of the electromagnet-energizing current. Secondary pressure feedback from the load port can act on an area defined by lands of the spool, which can have different diameters, or on the area formed by an axial hole in each end of the spool, thereby making the secondary pressure more controllable against disturbances. The valve can eliminate the need for a long, narrow internal hole in the spool and also provide an actuator chamber subjected only to a tank pressure by adding an additional tank port in the cage.

### CROSS-REFERENCE TO RELATED PATENT APPLICATIONS

This patent application claims the benefit of priority to U.S. Provisional Application No. 60/426,932, filed Nov. 15, 2002, entitled “Dual Proportional Pressure Reducing Valve,” which is incorporated in its entirety herein by this reference.

### FIELD OF THE INVENTION

This invention relates to dual proportional pressure control valves used to drive spool valves in hydraulic systems.

### BACKGROUND OF THE INVENTION

A proportional pressure control valve usually has a primary pressure port, a load port, and a tank port. The spool of the control valve is driven to a predetermined position by a magnetic force. With the spool in such position, an annular groove on the spool connects the primary pressure port and the load port, thereby providing a secondary pressure to a demanding device. In applications that drive a 3-position spool valve, a proportional pressure control valve is often mounted on each end of the 3-position spool valve to drive the spool in different directions toward different predetermined locations. This arrangement requires two primary pressure paths and ports, two proportional actuators and two cavities.

### SUMMARY OF THE INVENTION

The invention can provide a pressure control valve for controlling two pressure load paths. The pressure control valve can include a housing defining a single primary input pressure path, a first load path, and a second load path. The housing can have a cavity therein. A spool, which is slidably disposed in the cavity of the housing, and a dual proportional actuator including a movable plunger, can be provided. The plunger can be in operative engagement with the spool. The actuator can be selectively operable to move the spool via the plunger in a first direction or a second direction and to thereby dispose the spool in a neutral position wherein the first and second load paths are blocked, a first control position wherein the first load path is open and the second load path is blocked, and a second position wherein the second load path is open and the first load path is blocked. This arrangement can confer a cost-savings advantage over many prior art valves.

In an aspect of the invention, a dual proportional actuator can be provided that can drive the spool in opposite directions. A single spring can be used to keep the plunger and the spool in their neutral positions when the actuator is not energized and to return them to their neutral position after a drive current has disappeared, regardless of their location and previous direction of movement. An orifice can be provided in the spool to permit oil or other fluid to dampen movement of the spool.

In yet another aspect of the invention, a pair of tank ports can be provided to eliminate the need for a long, narrow internal hole in the spool. The tank ports can expose the actuator chamber only to the tank pressure.

In a further aspect of the invention, spool lands of different diameters can define an area. The lands can be exposed to a secondary pressure that generates a feedback force which acts against a drive force, thereby making the pressure at the load port more stable against disturbances. The control lands of the spool can be arranged such that the load ports are isolated from the primary port and connected to the tank ports when no magnetic force is present. When a magnetic force is present, one load port can be connected to the primary pressure port while the other load port is still connected to the tank port.

In still a further aspect of the invention, an area defined by an axial hole in the spool can be connected to the secondary pressure, thereby generating a feedback force against the magnetic force due to the presence of a sliding pin. A stop pin can absorb the force acting on the sliding pin. The stop pin can be mounted in a cage such that it absorbs the force acting on the sliding pin, which is generated in an amount substantially equal to the secondary pressure multiplied by the sliding pin area. A slot can be added to the spool to accommodate the stop pin, thereby permitting the spool to move freely.

These and other features of the present invention will become apparent to one of ordinary skill in the art upon reading the detailed description, in conjunction with the accompanying drawings.

### BRIEF DESCRIPTION OF THE DRAWINGS

FIG. 1 is a sectional view of an embodiment of a valve according to the present invention.

FIG. 2 is a sectional view of another embodiment of a valve according to the present invention.

FIG. 3 is a perspective view of a spool useful in connection with the valve of FIG. 2.

### DETAILED DESCRIPTION OF PREFERRED EMBODIMENTS OF THE INVENTION

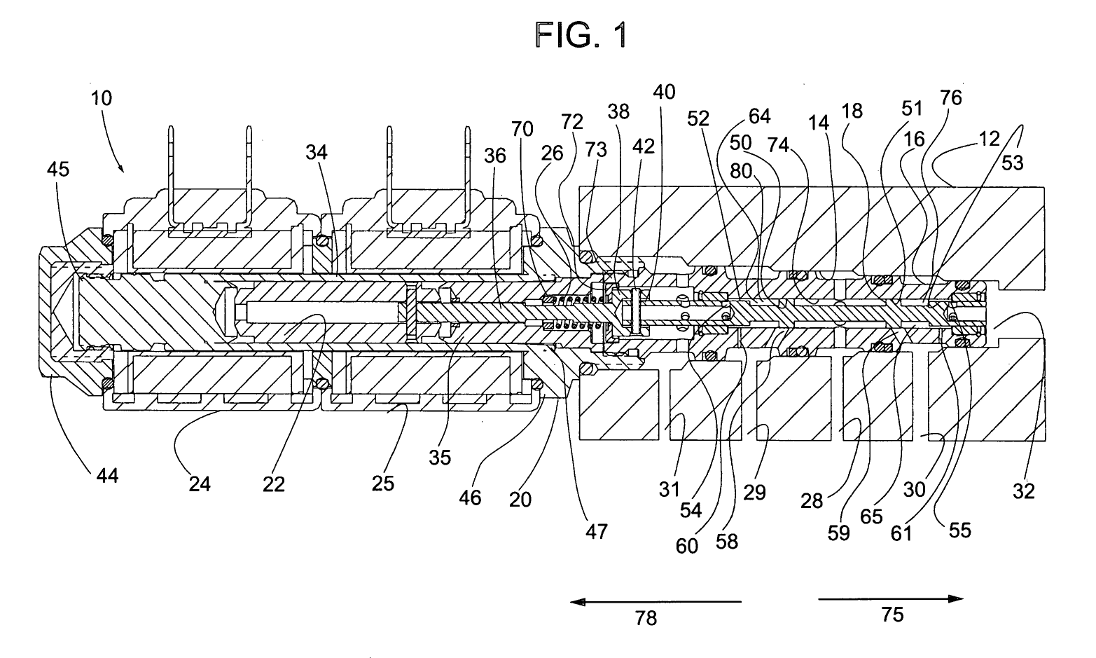

Referring to FIG. 1, an embodiment of a pressure control valve for controlling two pressure load paths 10 according to the present invention can comprise a housing 12 having a cavity 14 therein, a hollow cage 16 disposed in the cavity 14, a spool 18 slidably disposed in the cage 16, an electromagnet actuator 20 having an armature or plunger 22 and first and second solenoid coils 24, 25, and a spring 26 for biasing the spool 18 and the plunger 22 to a neutral position. The housing 12 has a primary pressure port 28, first and second load ports 29, 30, and first and second tank ports 31, 32 communicating with the cavity 14. The valve 10 can have other known components, such as, seals, for example, and can be constructed according to known techniques.

The actuator 20 can include a hollow tube 34 with the first and second solenoid coils 24, 25 wound therearound and the plunger 22 slidably arranged therein, a pole piece 35 anchored within the tube 34, and a push pin 36 attached to and extending from the plunger 22 and engaging the spool 18. The push pin 36 can include a yoke portion 38 which can receive an end portion 40 of the spool 18 therebetween. The push pin 36 and the spool 18 can be journaled together via a connector 42 for allowing the spool 18 and the push pin 36 to move together in tandem.

The actuator 20 can include a cap 44 threadedly engaged with one end 45 of the tube 34 and an adaptor 46 secured to the other end 47 thereof. The adaptor 46 can be mounted to the housing 12 and to the cage 16 such that they are disposed in fixed relationship with each other.

The spool 18 can have a first pair of inner lands 50, 51 and a second pair of outer lands 52, 53. The inner lands 50, 51 can have a different diameter than the outer lands 52, 53. The spool 18 can have first and second holes 54, 55.

The cage 16 can include first and second regulating ports 58, 59 and first and second orifices 60, 61, which respectively communicate with first and second interior chambers 64, 65 defined therein.

The spring 26 can be disposed between a retainer ring 70 mounted to the push pin 36 and a spacer 72 mounted to an end 73 of the cage 16.

When both coils 24, 25 of the electromagnet actuator 20 are in a de-energized state, the spool 18 and the plunger 22 are kept in their neutral positions by the spring 26. The first and second load ports 29, 30 are respectively connected to the first and second tank ports 31, 32 by the holes 54, 55. The inner spool lands 50, 51 define a chamber 74 t therebetween and can isolate the primary pressure port 28. The primary pressure port 28 is in communication with a primary input pressure path. The first load port 29 and the first tank port 31 are in communication with each other via a first discharge path. The second load port 30 and the second tank port 32 are in communication with each other via a second discharge path.

When a drive current is applied to the second coil 25 of the actuator 20, an electromagnetic force is created, which can drive the plunger 22 to overcome the force of the spring 26 and push the spool 18 in a first direction 75, to the right as shown in FIG. 1. The distance that the spool moves is proportional to the drive current. After moving a predetermined distance, the spool 18 opens the second regulating port 59 and simultaneously closes the second hole 55, thereby resulting in a secondary pressure at the second load port 30 and a blocking of communication between the second load port 30 and the second tank port 32. The second load port 30 and the primary pressure port 28 are in communication with each other via a second pressure load path. The second discharge path is closed and will not allow fluid to flow therethrough.

The secondary pressure can act on an area 76 defined by the second inner land 51 and the second outer land 53 through the second orifice 61, which stabilizes the secondary pressure at the second load port 30. On the other end of the spool 18, since the first hole 54 thereof remains open, the first load port 29 is still connected to the first tank port 31 through the first chamber 64. The first discharge path remains open, thereby allowing fluid to flow therethrough.

Once the drive current is removed from the second coil 25, the spring 26 can act to urge the spool 18 and the plunger 22 back to their neutral position.

When a drive current is applied to the first coil 24, an electromagnetic force is created, which drives the plunger 22 to overcome the force of the spring 26 and drag the spool 18 in a second direction 78, to the left as shown in FIG. 1, which is opposite to the first direction 75. The distance that the spool 18 moves is proportional to the drive current. After moving a predetermined distance, the spool 18 opens the first regulating port 58 and simultaneously closes the first hole 54 of the spool, thereby resulting in a secondary pressure at the first load port 29 and a blocking of communication between the first load port 29 and the first tank port 31. The first load port 29 and the primary pressure port 28 are in communication with each other via a first pressure load path. The first discharge path is closed and will not allow fluid to flow therethrough.

This secondary pressure can act on an area 80 defined by the first outer land 52 and the first inner land 50 through the first orifice 60 of the cage, which stabilizes the secondary pressure at the first load port 29. On the other end of the spool 18, since the second hole 55 of the spool remains open, the second load port 30 is still connected to the second tank port 32 through the second chamber 65. The second discharge path remains open, thereby allowing fluid to flow therethrough.

Once the drive current is removed from the first coil 24, the spring 26 can act to urge the spool 18 and the plunger 22 back to their neutral position.

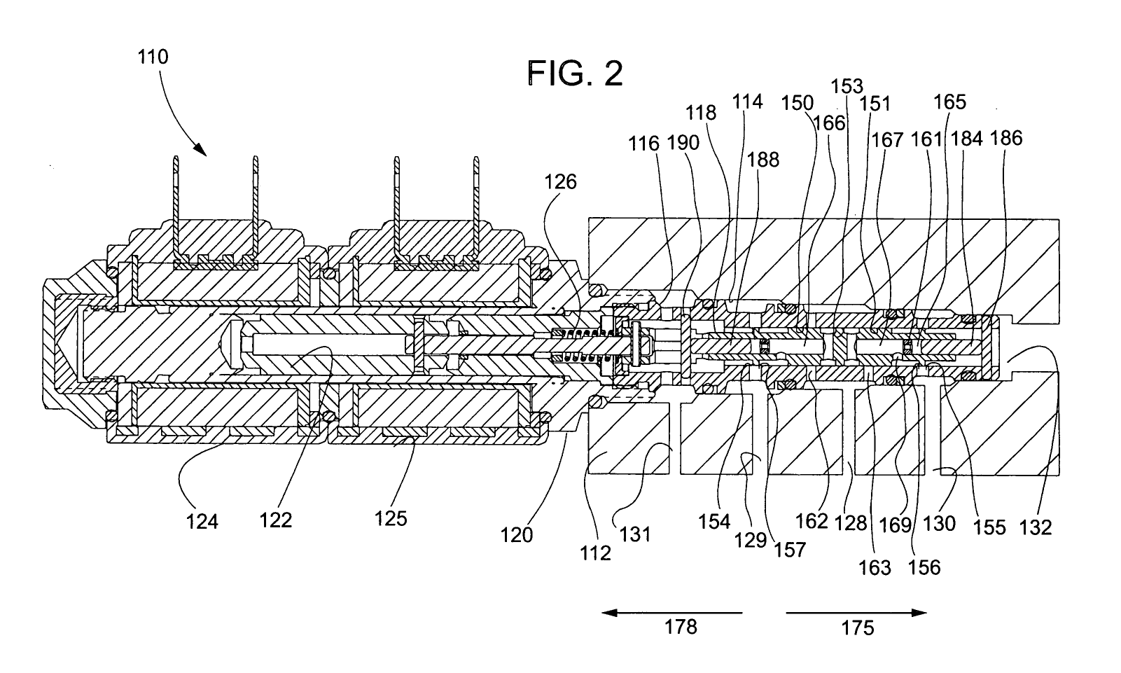

Referring to FIG. 2, another embodiment of a pressure control valve for controlling two pressure load paths 110 according to the present invention is shown. The valve 110 can comprise a housing 112 having a cavity 114 therein, a hollow cage 116 disposed in the cavity 114, a spool 118 slidably disposed in the cage 116, an electromagnet actuator 120 having an armature or plunger 122 and first and second solenoid coils 124, 125, and a spring 126 for biasing the spool 118 and the plunger 122 to a neutral position. The housing 112 has a primary pressure port 128, first and second load ports 129, 130, and first and second tank ports 131, 132 communicating with the cavity 114. The valve 110 can have other known components, such as, seals, for example, and can be constructed according to known techniques.

When the electromagnet actuator 120 is in a de-energized state, the spool 118 and the plunger 122 are kept in their neutral positions by the spring 126. The first and second load ports 129, 130 are respectively connected to the first and second tank ports 131, 132 by first and second partial ports 154, 155. Inner spool lands 150, 151 can isolate the primary pressure port 128.

When a drive current is applied to the second coil 125, an electromagnetic force is created that drives the plunger 122 to overcome the force of the spring 126 and to push the spool 118 in a first direction 175, to the right as shown in FIG. 2. The distance that the spool 118 moves is proportional to the drive current. After moving a predetermined distance, the spool 118 simultaneously opens a regulating port 163 of the cage, opens a third partial port 156, and closes the second partial port 155, thereby forming a secondary pressure. An intermediate land 153 of the spool 118 can act to isolate the secondary pressure.

The secondary pressure can be transferred to the second load port 130 through an axial hole 167, a radial hole 169, and the third partial port 156. The communication between the second load port 130 and the second tank port 132 is blocked at the same time by virtue of the second partial port 155 being closed. The secondary pressure can also act on an area defined by the axial hole 167 in the spool 118 and on the area of a sliding pin 184 inside the spool 118, which generates two opposite forces—a feedback force and a pushing force. The feedback force acts on the spool 118 against the magnetic force to stabilize the secondary pressure at the second load port 130. The pushing force acts on the sliding pin 184 to push the sliding pin 184 against a stop pin 186. On the other end of the spool, the first partial port 154 enlarges in response to the movement of the spool 118 to the right. Thus, the first load port 129 can maintain communication with the first tank port 131. Because of the movement of the sliding pin 184 inside the spool 118, the oil or other fluid flowing in or out of the chamber 165 through the orifice 161 dampens the movement of the spool 118.

When the drive current is applied to the first coil 124, an electromagnetic force is created that drives the plunger 122 to overcome the force of the spring 126 and to drag the spool 118 in a second direction 178, to the left as shown in FIG. 2, which is opposite to the first direction 174. The distance that the spool 118 moves is proportional to the drive current. After moving a predetermined distance, the spool 118 simultaneously opens the regulating port 162, opens a fourth partial port 157, and closes the first partial port 154, thereby forming a secondary pressure. The intermediate land 153 of the spool 118 can act to isolate the secondary pressure. The secondary pressure can be transferred to the first load port 129 through an axial hole 166, a radial hole 168, and the partial port 157. The communication between the first load port 129 and the first tank port 131 can be blocked at the same time by virtue of the first partial port 154 being closed. The secondary pressure can also act on an area defined by an axial hole 166 in the spool 118 and on the area of a sliding pin 188 inside the spool 118, which generates two opposite forces—a feedback force and a pushing force. The feedback force acts on the spool 118 against the magnetic force to stabilize the secondary pressure at the first load port 129. The pushing force acts on the sliding pin 188 to push the sliding pin 188 against a stop pin 190. On the other end of the spool, the second partial port 155 enlarges in response to the movement of the spool 118 to the left. Thus, the second load port 130 can maintain communication with the second tank port 132. Because of the sliding pin 188 moving inside the spool 118, the oil or other fluid flowing in or out of the chamber 164 through the orifice 160 dampens the movement of the spool 118.

The valve 110 of FIG. 2 can be similar in other respects to the valve 10 of FIG. 1 shown and described herein.

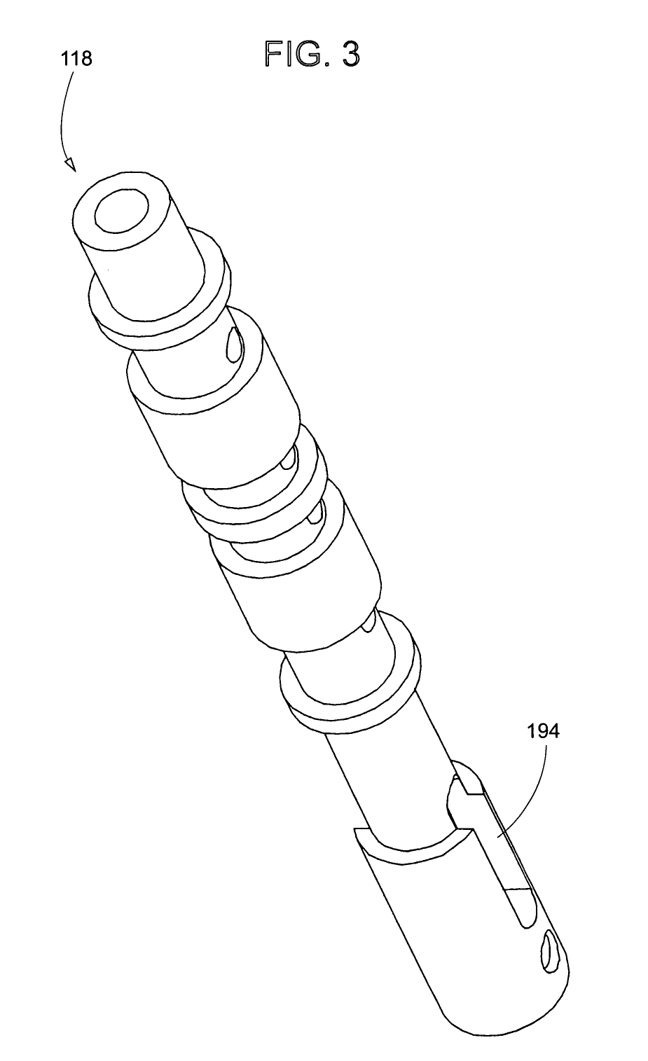

Referring to FIG. 3, the spool 118 can include at least one slot 194 to accommodate the stop pin.

All references, including publications, patent applications, and patents, cited herein are hereby incorporated by reference

The use of the terms “a” and “an” and “the” and similar referents in the context of describing the invention is to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended to illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pressure control valve for controlling two pressure load paths, the pressure control valve comprising:
a housing defining a single primary input pressure path, a first load path, and a second load path, the housing including a cavity therein;
a spool, the spool slidably disposed in the cavity of the housing; and
a dual proportional actuator including a movable plunger, the plunger in operative engagement with the spool, the actuator selectively operable to move the spool via the plunger in a first direction or a second direction, the actuator operable to dispose the spool in a neutral position wherein the first and second load paths are blocked, a first control position wherein the first load path is open and the second load path is blocked, and a second position wherein the second load path is open and the first load path is blocked.

2. The valve according to claim 1 wherein the housing defines a primary pressure port in communication with the primary pressure path, first and second load ports, and first and second tank ports, the first load port being selectively connected to the primary pressure port via the first load path, the second load port selectively connected to the primary pressure port via the second load path, and the first and second load ports being respectively selectively connected to the first and second tank ports via first and second drain paths,.

3. The valve according to claim 2 wherein moving the spool in the first direction a predetermined distance from a neutral position blocks communication between the second tank port and the second load port and maintains the connection of the first tank port and the first load port, and moving the spool in the second direction a predetermined distance from a neutral position blocks communication between the first tank port and the first load port and maintains the connection of the second tank port and the second load port.

4. The valve according to claim 3 wherein the spool includes a plurality of lands, the lands configured such that a first secondary pressure develops at the first load port when the communication between the first tank port and the first load port is blocked and such that a second secondary pressure develops at the second load port when the communication between the second tank port and the second load port is blocked.

5. The valve according to claim 4 wherein the spool includes a plurality of lands configured to isolate the primary pressure path.

6. The valve according to claim 4 wherein the spool includes a plurality of lands, at least two of which have different diameters, the spool lands of different diameters defining an area which is exposed to the first secondary pressure to thereby generate a feedback force which acts against a drive force.

7. The valve according to claim 6 wherein the spool includes at least three lands, the spool lands of different diameters defining an area which is exposed to the first and second secondary pressures to thereby generate a respective feedback force which acts against a respective drive force.

8. The valve according to claim 1 wherein the spool includes a plurality of lands configured to isolate the primary pressure path.

9. The valve according to claim 1 wherein when the actuator is operated an electromagnetic field is generated, and when the spool is in either of the first and second positions, a pressure differential develops within the spool, the spool being configured such that it moves in response to the difference between the differential pressure and the magnetic field of the actuator.

10. The valve according to claim 2 wherein the spool includes a differential area associated with each load port, each differential are being exposed to the pressure in the load port.

11. The valve according to claim 10 wherein when the actuator is operated an electromagnetic field is generated, and when the spool is in either of the first and second positions, a pressure differential develops within the spool, the spool being configured such that it moves in response to the difference between the differential pressure and the magnetic field of the actuator.

12. The valve according to claim 1 wherein the dual proportional actuator comprises a pair of solenoid coils.

13. The valve according to claim 1 wherein the plunger of the dual proportional actuator includes a push pin connected to the spool.

14. The valve according to claim 1 further comprising:
a cage disposed in the cavity of the housing, the cage fixed with respect to the housing, the spool slidably disposed within the cage.

15. The valve according to claim 1 further comprising:
a spring engaged with the plunger and the spool, the spring acting to bias the plunger and the spool to a neutral position.

16. The valve according to claim 4 further comprising:
a sliding pin disposed inside the spool;
a stop pin configured to be engageable with the sliding pin;
wherein the secondary pressure developed when the communication between the first load port and first tank port is blocked acts on the sliding pin to generate two opposing forces, one of which acts on the spool to stabilize the secondary pressure at the first load port, and the other of which acts on the sliding pin to move the sliding pin against the stop pin.

17. A pressure control valve for controlling two pressure load paths, the pressure control valve comprising:
a housing defining a single primary pressure path and at least one port, the housing including a cavity therein;
a cage disposed in the cavity of the housing, the cage fixed with respect to the housing;
a spool, the spool slidably disposed within the cage, the spool includes a plurality of lands configured to isolate the primary pressure path;
a dual proportional actuator including a movable plunger, the plunger in operative engagement with the spool, the actuator selectively operable to move the spool via the plunger in a first direction or a second direction;
a spring engaged with the plunger and the spool, the spring acting to bias the plunger and the spool to a neutral position;
wherein moving the spool in the first direction a predetermined distance from a neutral position blocks communication between the second tank port and the second load port and maintains the connection of the first tank port and the first load port, and moving the spool in the second direction a predetermined distance from a neutral position blocks communication between the first tank port and the first load port and maintains the connection of the second tank port and the second load port.
